(19) United States
(12) Patent Application Publication
(10) Pub. No.: US 2009/0295963 A1
(43) Pub. Date: Dec. 3, 2009

(54) METHOD AND APPARATUS AND COMPUTER PROGRAM PRODUCT FOR COLLECTING DIGITAL IMAGE DATA FROM MICROSCOPE MEDIA-BASED SPECIMENS

(76) Inventors: Pascal Bamford, Mundelein, IL (US); William J. Mayer, South Barrington, IL (US)

Correspondence Address: GOODWIN PROCTER LLP;PATENT ADMINISTRATOR, 53 STATE STREET, EXCHANGE PLACE, BOSTON, MA, 02109-2881, US

(21) Appl. No.: 12/278,532

(22) PCT Filed: Feb. 9, 2007
(86) PCT No.: PCT/US07/03484

§ 371 Date: Jun. 18, 2009

Related U.S. Application Data
(60) Provisional application No. 60/771,893, filed on Feb. 10, 2006.

(51) Int. Cl. H04N 5/225; H04N 3/14; H04N 9/04

(52) U.S. Cl. 348/302; 348/335; 348/360; 348/E09.01; 348/E05.024; 348/E03.017

(57) ABSTRACT

A digital image collection system and method includes an area scan camera that scans a region to obtain digital image data therefrom, the area scan camera having an optical scan axis. A specimen mounting unit receives a specimen that is mounted on a top surface thereof, for enabling the specimen to be scanned by the area scan camera. The top surface of the specimen mounting unit is slanted at an angle with respect to the area scan camera such that the optical scan axis is oblique to the top surface of the specimen mounting unit.

### RELATED APPLICATIONS

This application claims priority to U.S. Provisional Patent Application No. 60/771,893, entitled METHOD AND APPARATUS FOR COLLECTING DIGITAL IMAGE DATA FROM MICROSCOPE-BASED SAMPLES, filed on Feb. 10, 2006, which is incorporated in its entirety herein by reference.

### FIELD OF THE INVENTION

The present invention relates generally to a system and method and computer program product for obtaining digital images of specimens mounted on or within microscope media, and more particularly, to a system and method for rapid, high-resolution image acquisition with extended depth of field. In certain embodiments, the present invention provides multi-focal-plane images that are particularly suited to the digitization of optically thick specimens using transmitted light imaging modalities.

### BACKGROUND OF THE INVENTION

The digitization of microscope media is of significant clinical and research interest. It is an essential first step in computerized automated and semi-automated image processing and analysis. Additionally, digital images are increasingly used for education, training, proficiency testing and collaboration in pathology. The aim of such digitization is to obtain faithful representations of that which may be observed in traditional optical transmitted light microscopy. From an engineering perspective, it is therefore necessary to produce images of a similar spatial (X, Y and Z dimensions) and radiometric (both spectral and photometric) resolution to that achieved in traditional microscopy. Furthermore, the images should contain no detectable artifacts and be captured in a reasonable time frame, for example in less than five minutes for all available fields of view on a microscope slide substrate.

Specimens mounted on or contained within microscope media are three-dimensional objects. Thus it is possible to conceive of the specimen as a volume to be digitized. Furthermore, the dimension of time may also be digitized resulting in a four-dimensional image or video data sequence. Until recently, digital microscopy has been limited to the capture of incomplete volumes representing a subset of the specimen mounted or contained within the microscope medium. This is especially the case in applications where high spatial resolution is required. One reason for this limitation is due to the limited field of view, or volume, of the media that may be digitized at any one time with conventional microscope apparatus. For example at a 40× objective magnification, a camera sensor of active imaging dimensions 10 mm×10 mm projects a two-dimensional sampling area at the field of 0.25 mm×0.25 mm. Sampling in the Z dimension is determined by the optical depth of field of the system (the distance in the Z-axis in which objects are in sharp focus). At a 40× objective magnification, the depth of field of conventional microscope optics is on the order of 1 micrometer. In this example it is therefore only possible to sample an in-focus specimen volume of 0.25 mm×0.25 mm×0.001 mm at each camera exposure. In order to digitize a volume greater than this inherent optical field, or volume, of view, it is necessary to capture multiple images at adjacent locations in X, Y and Z to form a ‘mosaic’ of the enlarged area. At high optical magnification, for example at a 40× objective magnification, it may be necessary to capture many tens of thousands of such images to exhaustively digitize even a modestly sized volume in all dimensions. This typically results in an acquisition time of several hours due to the large multiplicative effect on mechanical stage movements and camera exposure times.

A further limitation on exhaustive digitization has been the associated large data file sizes that have made the storage, networking and processing, whether visual or automated, of these files require expensive hardware. This limitation has been addressed recently with rising computational power, faster networks, less costly storage and new image formats that have been designed for such applications, such as JPEG2000. Of particular relevance to the present invention, the JPEG2000 format consists of a multi-component transform module that is able to take advantage of the redundant information present in multi-focal plane images, greatly reducing the associated file size and increasing the efficiency of processing spatially three-dimensional images.

While the main shortcoming of traditional approaches is lengthy acquisition times, a further shortcoming is the necessity to automatically and ‘seamlessly’ mosaic each individual field of view image into a single montage. These issues with traditional digitization are discussed in detail in the prior art, for example U.S. Pat. No. 6,711,283.

Several systems have recently addressed the speed of acquisition issue associated with traditional methods of microscope-based digitization. While these systems have achieved success in this aim, they generally sample exhaustively in only two-dimensions (X and Y). Therefore, for specimens that are optically thicker than the depth of field of the optics used for digitization, these systems produce only partially focused images. The present invention addresses this shortcoming by providing a method for exhaustively sampling the z dimension simultaneous to sampling in the x and y dimensions.

Aperio Technologies, Inc. developed the ScanScope system that comprises a linear array camera and moving stage that operated in a manner similar to familiar flatbed document scanners and is described in U.S. Pat. No. 6,711,283. This system captures a single plane of focus at each spatial location, resulting in partially focused images for optically thick specimens. To reduce this effect, the system comprises of a pre-scan stage to obtain a focal map that directs the scanning stage to areas of optimal focus across the specimen.

Interscope Technologies, Inc. developed the Xcellerator system that comprises an area-scan camera, moving stage and strobe light source that eliminates image blurring due to the moving stage and is described in WO 03/012518. The speed of acquisition issue is addressed as the stage constantly moves, eliminating the delay period associated with traditional stop-capture-go systems. This system also captures image at a single plane of focus and minimizes focal errors via a pre-scan focal mapping sequence.

DMetrix, Inc. developed the DX-40 system that comprises a miniature optical array that is able to image a slide in parallel and hence arrive at ultra-rapid scanning times. While this system achieves fast acquisition times, it does so only at a single plane of focus during each pass of the medium. This system is described in WO 2004/028139.

A key issue in systems that digitize at a single plane of focus is maintaining an optimal Z position during scanning such that as much of the specimen as possible is in sharp focus. Trestle Corporation developed a method for obtaining focal information by tilting the camera or camera sensor relative to the optical axis and is described in WO2005/010495. This focal information was used to position the Z-axis for a secondary image capture sequence.

Further disadvantage of single plane of focus systems is lack of scalability. In order to convert these systems to capture multiple planes of focus, it is necessary to perform one additional scan of the entire specimen for each additional plane of focus required. Since this must be performed serially, the time penalty associated with this approach is multiplicative. Furthermore, each focal plane must be co-registered to produce an accurate three-dimensional image. This is not a trivial operation due to the accumulation of positional errors during each scan.

Relevant patents in the area of slide digitization include, among others, WO 03/073153 entitled “Optimized image processing for wavefront coded imaging systems” and U.S. Pat. No. 6,072,624 entitled “Apparatus and method for scanning laser imaging of macroscopic samples”.

### SUMMARY OF THE INVENTION

The present invention provides a method for rapidly digitizing specimens mounted on or within microscope media at high X and Y spatial resolution simultaneous to the capture of multiple planes of focus to additionally and exhaustively digitize the Z dimension. In a preferred application, this is accomplished by slanting the microscope media to the optical axis so that the plane of the media (and hence the plane of the specimen) is not positioned orthogonal to the optical axis.

In one aspect, the present invention provides a three-dimensional image with X, Y and Z spatial resolution comparable to that that may be observed in traditional microscopy in a similar timeframe to systems that capture only a single plane of focus in X and Y.

In another aspect, the present invention provides an image whereby multiple planes of focus are synthetically compressed to a single plane, thus rendering all image objects in focus in a single image and removing any requirement to navigate the image in three dimensions during both visual assessment and computerized analysis.

A digital image collection system according to one aspect of the invention includes an area scan camera configured to scan a region to obtain digital image data therefrom, the area scan camera having an optical scan axis. The system also includes a specimen mounting unit configured to receive a specimen that is mounted on a top surface thereof, for enabling the specimen to be scanned by the area scan camera. The top surface of the specimen mounting unit is slanted at an angle with respect to the area scan camera such that the optical scan axis is oblique (not orthogonal) to the top surface of the specimen mounting unit.

A digital image collection method according to yet another aspect of the invention includes mounting a specimen on a top surface of a specimen mounting unit, for enabling the specimen to be scanned by an area scan camera, the area scan camera having an optical scan axis. The method further includes scanning a region with the area scan camera to obtain digital image data therefrom. The method still further includes processing the digital image data to obtain a three-dimensional image of the specimen based on a single pass of the specimen with respect to the area scan camera. The top surface of the specimen mounting unit is slanted at an angle with respect to the area scan camera such that the optical scan axis is oblique to the top surface of the specimen mounting unit.

According to still another aspect of the invention, there is provided a computer program product embodied in computer readable media, the computer program product, when executed on a computer, causing the computer to perform a step of, after a specimen has been mounted on a top surface of a specimen mounting unit, for enabling the specimen to be scanned by an area scan camera, in which the area scan camera has an optical scan axis, scanning a region with the area scan camera to obtain digital image data therefrom. The computer then performs a step of processing the digital image data to obtain a three-dimensional image of the specimen based on a single pass of the specimen with respect to the area scan camera. The top surface of the specimen mounting unit is slanted at an angle with respect to the area scan camera such that the optical scan axis is oblique to the top surface of the specimen mounting unit.

### BRIEF DESCRIPTION OF THE DRAWINGS

The accompanying drawings, which are incorporated in and constitute a part of this specification, illustrate exemplary embodiment(s) of the invention and, together with the general description given above and the detailed description of the embodiment(s) given below, serve to explain the principles of the invention.

FIG. 1 illustrates the Cartesian coordinate system used in FIG. 2, FIG. 3 and FIG. 4. Note that the X and Z dimensions are coplanar to the paper, whilst they dimension is orthogonal to the paper.

FIG. 2 is a diagrammatic, two-dimensional side elevational view of the optical configuration of the invention illustrating the slanted field relative to the optical axis, the slant angle being greatly exaggerated for illustration purposes.

FIG. 3 is a diagrammatic perspective view that illustrates the subset of pixels required to exhaustively sample the Z dimension of the field, the slant angle being greatly exaggerated for illustration purposes.

FIG. 4 is a diagrammatic view that illustrates the process by which three-dimensional image information is derived as a series of stacked pixels from the moving image field within the microscope media, the slant angle being greatly exaggerated for illustration purposes.

FIG. 5 illustrates multispectral image capture according to an embodiment of the invention.

FIG. 6 illustrates an example Bayer pattern used in color cameras to obtain RGB spectral information for color image synthesis.

FIG. 7 illustrates how a Bayer color camera may be used in the invention to obtain ROB color images, according to an embodiment of the invention.

FIG. 8 illustrates the gathered spectral data using a Bayer camera and how only a single color component must be interpolated for each image pixel, according to an embodiment of the invention.

FIG. 9 is a flow chart showing the steps involved in a digital image data collecting method according to an embodiment of the invention.

FIG. 10 is a perspective view of a digital image data collecting device according to an embodiment of the invention.

FIG. 11 is a view of a portion of the digital image data collecting device of FIG. 10, showing details of the specimen mounting area and the camera mounting area.

FIG. 12 is an enlarged, detail view of a portion of the digital image data collecting device of FIG. 10, showing details of the gimbal mount and calibrations.

### DETAILED DESCRIPTION OF THE INVENTION

The invention is described below with reference to the drawings. These drawings illustrate certain details of specific embodiments that implement the systems and methods and programs of the present invention. However, describing the invention with drawings should not be construed as imposing on the invention any limitations that may be present in the drawings. The present invention contemplates methods, systems and program products on any machine-readable media for accomplishing its operations. The embodiments of the present invention may be implemented using an existing computer processor, or by a special purpose computer processor incorporated for this or another purpose or by a hardwired system.

As noted above, embodiments within the scope of the present invention include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such a connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

Embodiments of the invention will be described in the general context of method steps which may be implemented in one embodiment by a program product including machine-executable instructions, such as program code, for example in the form of program modules executed by machines in networked environments. Generally, program modules include routines, programs, objects, components, data structures, etc. that perform particular tasks or implement particular abstract data types. Machine-executable instructions, associated data structures, and program modules represent examples of program code for executing steps of the methods disclosed herein. The particular sequence of such executable instructions or associated data structures represent examples of corresponding acts for implementing the functions described in such steps.

Embodiments of the present invention may be practiced in a networked environment using logical connections to one or more remote computers having processors. Logical connections may include a local area network (LAN) and a wide area network (WAN) that are presented here by way of example and not limitation. Such networking environments are commonplace in office-wide or enterprise-wide computer networks, intranets and the Internet and may use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing the overall system or portions of the invention might include a general purpose computing device in the form of a computer, including a processing unit, a system memory, and a system bus that couples various system components including the system memory to the processing unit. The system memory may include read only memory (ROM) and random access memory (RAM). The computer may also include a magnetic hard disk drive for reading from and writing to a magnetic hard disk, a magnetic disk drive for reading from or writing to a removable magnetic disk, and an optical disk drive for reading from or writing to a removable optical disk such as a CD-ROM or other optical media. The drives and their associated machine-readable media provide nonvolatile storage of machine-executable instructions, data structures, program modules and other data for the computer.

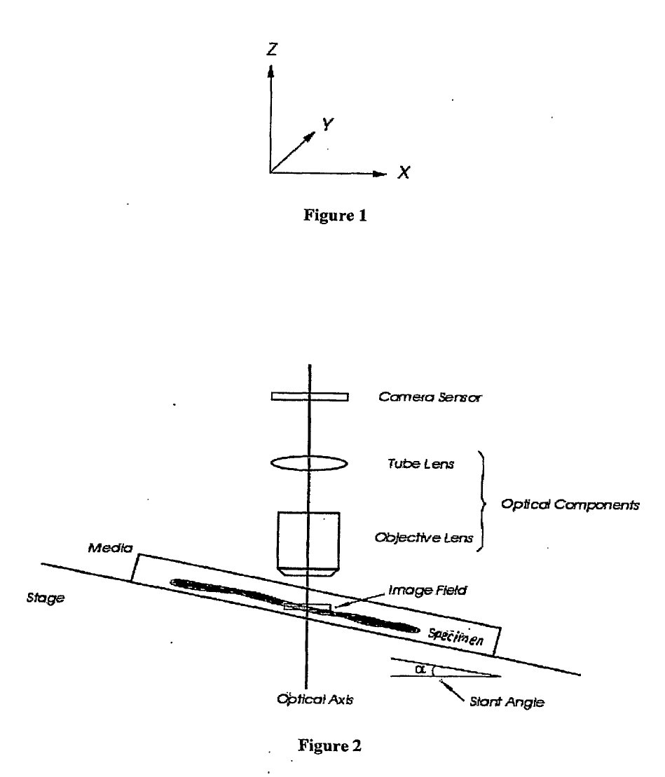

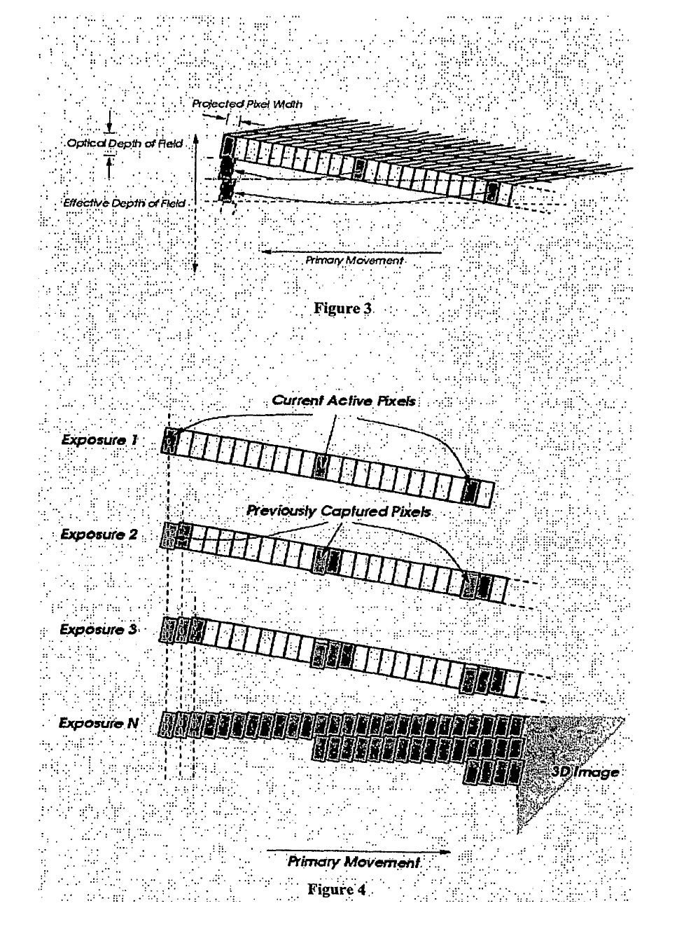

In general, the present invention is directed toward a digitization system that captures at least three-dimensional image information without the requirement to perform multiple scanning sequences of the same spatial location in the target media, removing the requirements of performing pre-scan focus mapping steps and multiple image capture in z to obtain optical sections that exhaustively sample the Z dimension. In the preferred embodiment, this is achieved by slanting the media on or in which the specimen is mounted relative to the optical axis, as illustrated in FIG. 2. Alternative methods of achieving a focal gradient at the image plane may be used. The area marked ‘Image Field’ illustrates the three-dimensional imaging volume that is projected onto the two-dimensional camera sensor by the optical components. This image field is characterized by its X, Y and Z dimensions. Only objects within this volume will be represented at the camera sensor in sharp focus. The x, y and Z position of the image field is generally fixed by the static placement of the optical components. FIG. 1 illustrates the Cartesian coordinate system used in FIG. 2, FIG. 3 and FIG. 4. Note that the X and Z dimensions are coplanar to the paper, whilst the Y dimension is orthogonal to the paper.

FIG. 2 shows the optical configuration of the invention comprising a camera sensor, a tube lens, objective lens, whereby the tube lens and the objective lens correspond to standard microscope optical components. Also shown in FIG. 2 is a specimen mounting unit (or stage) that receives a media-mounted specimen that is mounted on a top surface thereof, for enabling the specimen to be scanned by the area scan camera. The top surface of the specimen mounting unit is slanted at an angle α with respect to the area scan camera, such that the optical scan axis of the area scan camera is not orthogonal (e.g., oblique) to the top surface of the specimen mounting unit. FIG. 2 also shows an image field that corresponds to a region of the specimen that is currently being scanned by the area scan camera.

In order to image the specimen that lies outside of the image field exhaustively, it is necessary in existing systems to displace the media so that the next volume to be digitized is placed within the three dimensional area of the image field. The X and Y displacement is generally provided by a scanning electromechanical stage. The Z displacement is generally provided by the mechanical stage or equivalently by a piezo-actuated objective lens or some other mechanism or combination of mechanisms. Existing systems place the media at an angle orthogonal to the optical axis resulting in an in-plane sampling of the Z-axis. A shortcoming of this approach is that in order to exhaustively sample the Z dimension of the specimen, it is necessary to displace the Z dimension of the image field and capture multiple images. In contrast, by slanting the media in accordance with the present invention, a focal gradient is projected onto the camera sensor such that different focal depths are sampled across sensor. If the slant angle is sufficient, it is possible to exhaustively sample the Z dimension of the specimen without further displacements in the Z-axis. It then becomes necessary only to displace the sample in the X and Y dimensions to exhaustively sample the specimen in three dimensions.

The necessary slant angle to exhaustively sample the z dimension of a specimen may be computed as the ratio of the optical thickness of the specimen, dₗ, and the projected sensor dimension at the field, dₛ. This ratio may be represented as an angle from the orthogonal to the optical axis by arctan(dₗ/dₛ). An example will illustrate that even for relatively thick specimens, this angle remains small. Assuming a specimen optical thickness of 20 micrometers, an objective magnification of 40× and a camera sensor with in-plane dimension of 10 millimeters, the necessary slant angle is only 4.57 degrees (arctan (0.02/(10/40)). Assuming an optical depth of field, d₀, of 1 micrometer, this angle offers an effective depth of field that is twenty times greater than traditional systems. By way of example and not by way of limitation, the slant angle may vary between 2 degrees and 10 degrees with respect to the optical axis of a camera that is used to scan the specimen.

In the preferred embodiment, an area scan camera is used as the imaging sensor in the image plane. Alternative embodiments may include a series of line scan cameras mounted optically such that each receives a unique focal position or a lens configuration that imposes a focal gradient on an area scan camera or cameras. Other configurations will occur to those skilled in the art. FIG. 3 illustrates a view of such an area scan camera such that the pixel columns are parallel with a primary X direction of movement and the pixel rows are orthogonal to this direction, whereby an optical depth of field is also shown. The focal gradient at the image sensor is shallow, which results in adjacent pixel rows corresponding to very similar focal positions. In the preferred embodiment, it suffices to read only those pixel rows that are adjacent in Z as sampling in the X and Y dimensions is afforded by a primary and secondary movement of the media in the field plane as described below. Thus, it is only necessary to read M=dₗ/d₀ evenly spaced rows across the sensor, i.e. 20 rows using the above example of a specimen optical depth of 20 micrometers and a depth of field of 1 micrometer. On modern digital cameras, this subsampling of the camera pixels allows a linear increase in frame rate. Therefore, if only 20 1×1024 rows are captured from a 1024×1024 device less than 2% of the pixels are required leading to a 50× multiplier on the camera full frame frame rate. As camera throughput is the only limiting factor on the design, this aids highly rapid 3D image capture.

The area scan camera effectively acts as a series of line scan cameras that are optically positioned at unique z positions. Herein lies a valuable source of flexibility of the invention, as pixel rows may be selected in software for different magnifications, effective depths of field and Z sampling rates. Adjacent pixel rows may be selected with knowledge of the depth of field of the camera optics and the slant angle of the media to fully sample the specimen in the Z dimension.

The media is moved in a primary X direction that is parallel to the direction of the slant angle. This movement is conducted at a constant velocity such that during each image exposure timeframe, the media moves less than one projected pixel width. At each exposure epoch, the M Z-adjacent pixel rows are read from the camera. The next exposure epoch is timed such that the same pixel rows are exactly adjacent in the primary movement direction to those captured in the previous epoch. FIG. 4 illustrates that if this process is repeated for N exposures (N being a positive integer), the captured pixel rows will effectively stack upon another in the X, Y and Z dimensions, thus creating a three dimensional image. It should be noted that FIG. 4 is a cross-sectional view displaying only the X and Z digitization process. The Y-axis digitization occurs perpendicular to this as defined by FIG. 1. In Exposure 1, the pixels that are captured are shown as black-colored pixels. In Exposure 2, pixels adjacent to the previously captured pixels are captured (those newly-captured pixels being directly behind the previously captured pixels, with respect to a primary movement direction), and are shown as gray-colored pixels. In Exposure 3, pixels adjacent to the pixels previously captured in Exposure 3 are captured, and are shown as gray-colored pixels. This process is repeated up to Exposure N, whereby all of the pixels have been captured by this time, in order to obtain a three-dimensional image of the specimen.

The media is moved in the primary direction over a distance that is equal or greater to the dimension of the specimen in that same direction. Distances less than this will result in a sub-sampling of the specimen that may be desired in some embodiments. Whilst this exhaustively digitizes the specimen in X and Z, the Y dimension is only sampled by a distance that is determined by the Y dimension of the camera sensor and the magnification of the optics. In order to exhaustively digitize the sample in the Y dimension, multiple swaths are digitized by moving the media in a secondary direction that is orthogonal to the primary direction thus resulting in a raster scan pattern. The distance of this secondary movement is preferably such that consecutive swaths are adjacent the projectedy dimension of the camera's sensor in the field plane.

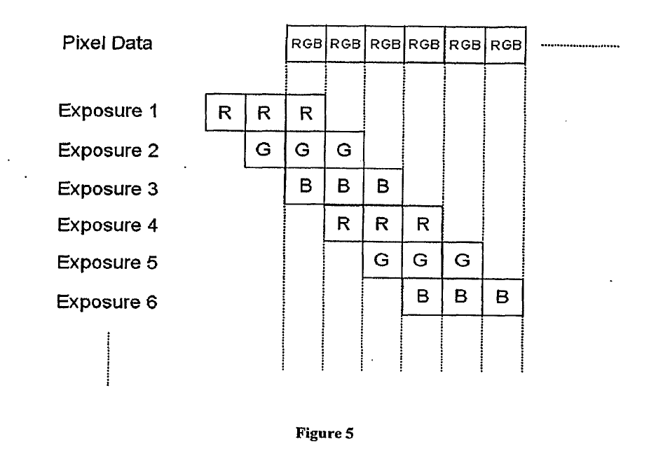

The above description relates a method whereby single pixel-wide rows are gathered corresponding to M adjacent focal Z positions. It will be obvious to those skilled in the art that it is possible only to capture monochromatic image information in this manner. In some embodiments it may be necessary to capture multi-spectral data (where red-green-blue (RGB) is one example and suited for human visual assessment). The invention naturally lends itself to multi-spectral or multi-wavelength data capture. The analogy of using an area-scan camera as a series of line-scan cameras may be extended to incorporate this concept. RGB line scan cameras are generally constructed with, for example, three columns of pixels where each column is responsible for gathering only one of the RGB components (usually using bandpass microlens filters at each pixel). Each spatial location to be digitized in the field is sampled by each of the columns serially such that the RGB data is gathered in a manner similar to the 3D information gathered by this invention. The invention as described so far only digitizes each X, Y, Z spatial location once, hence allowing only monochromatic image capture. However, by capturing L rows rather than one at each of the M adjacent Z positions, multi-spectral image capture is straightforward. FIG. 5 illustrates an example for the RGB case where only one of the M camera sensor regions of interest is considered. A monochromatic camera is assumed in this example. At each exposure epoch, all L rows are exposed using a first wavelength of light (in this case red). At the next exposure epoch, a second wavelength of light (in this case green) is emitted by the light source and all L rows again captured. This is repeated for all L wavelengths of the multi-spectral light source (in this case L=3). Once all L wavelengths have been sampled, the process repeats itself such that every pixel will have all wavelength data. This process is simplest to visualize as a mimic of RGB line scanning however the invention is limited neither to RGB nor three wavelengths of light.

It should be noted that during multispectral image capture, each of the M rows is not perfectly aligned in Z due to the imposed focal gradient at the image sensor. For a small number of wavelengths (e.g., three for RGB), this difference in z is negligible. Furthermore, multispectral image data is rarely combined as it is for human visual assessment (i.e., RGB) where each spectral component is used simultaneously to generate an image. This point is expanded by taking the case of a multiplexed specimen slide where a number of diagnostic markers (optionally employing quantum dots or some other signal amplification technology) emit signals at different wavelengths of light. Usually, the quantification of each of these signals will initially be processed independently (although there may be data fusion and multi-dimensional pattern recognition methods later applied to the initial quantification data). Therefore, as long as the multispectral data for each signal is exhaustively sampled in X, Y and Z, it is not a fundamental requirement that each of these signals is spatially aligned in Z.

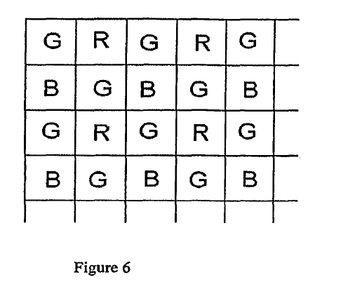

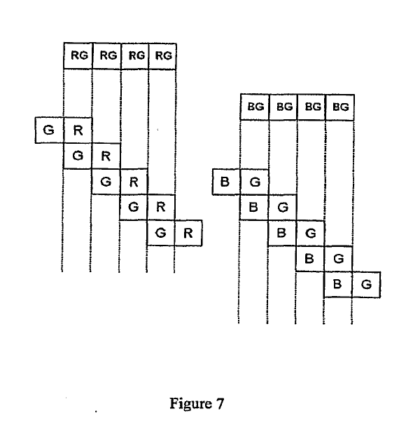

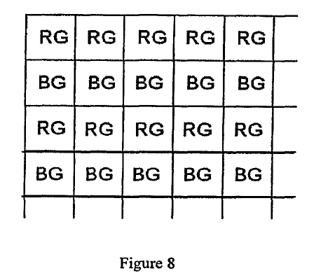

On the issue of RGB data capture, the invention is not limited to the above case whereby a monochromatic camera is used in conjunction with a multi-spectral light source. Most ‘color’ cameras employ a Bayer mask approach to capturing RGB data. An example Bayer mask is illustrated in FIG. 6. Here each pixel only gathers spectral data from a single wavelength of light (in reality, broadband RGB filters are employed in these cameras, however a single wavelength is assumed here for simplicity of explanation) and complete RGB data is obtained for each pixel via a post-capture interpolation process. This type of camera is compatible with the invention for RGB image capture by employing a similar technique as described above. In this case, two rows are captured at each of the M adjacent Z positions rather than one for the monochromatic case. FIG. 7 illustrates how partial color information is gathered by capturing two rows at each exposure epoch. The illustration considers the first two columns of these two rows where the pixel masks are green-red and green-blue respectively. Due to the Bayer pattern, where there are twice as many green pixels as red and blue, every pixel will contain green information and either red or blue at the completion of such image capture. This is illustrated in FIG. 8. The remaining color component for each pixel is then obtained via interpolation in a manner similar to traditional RGB color capture. An advantage of the invention over conventional color interpolation is that only one color component is interpolated at each pixel, rather than two. It will be recognized by those skilled in the art that a Bayer camera may also be used to capture only red, green, or blue data, or any combination of one, two or all three spectral components.

The above examples have assumed that the specimen lies perfectly in plane with the media such that the z image ‘stack’ captures all objects without further adjustments. Although the present invention captures a greatly extended depth of field, in reality the specimen does not lie at a single position in z across the entire medium. If the z scanning position of the image field were fixed, this variation could exceed the extended depth of field sampling of the invention resulting in out of focus images. Therefore, in some embodiments the overall Z stack position is adjusted across the specimen to allow for variations in media planarity and specimen deposition. This is readily achieved in the present invention, as real-time focal information is inherent in the technique. For each X, Y spatial location a focus metric is computed using standard techniques. The overall Z stack position is then finely adjusted, if necessary, in order to locate the specimen within the stack. Focal information can only be computed for locations where complete Z information is available. Due to the latency in the accumulation of this data in the invention, this information is offset by a distance equal to the projected image sensor dimension in the scanning direction. This latency does not affect focusing accuracy in practice as focal deviations are much more gradual as compared to the response time of Z repositioning. Therefore making fine adjustments to the Z position of the image field is possible without the requirement to conduct multiple passes over the same spatial location.

The slant angle imposes two artifacts on the final 3D image data. A first artifact is that the vertical Z dimension is skewed by the slant angle. This means that as objects are viewed through the Z dimension in uncorrected image data, a small lateral spatial shift may be observed. This is trivially corrected via an image re-sampling translation post-process. Furthermore, the lateral shift is well characterized by knowledge of the scanning slant angle making the correction fixed for all captured data. The second artifact is also due to the skewed vertical dimension. The blurring function of a microscope optical configuration may be viewed as a double cone whereby the points of each cone intersect at the plane of optimal focus. If a specimen is defocused through these cones in a perfectly orthogonal manner, then the formed image defocuses evenly. However, if the specimen is placed at an oblique angle in these cones and again defocused, the formed image will not defocus evenly. This second artifact is minor for small slant angles and only applicable to out of focus image data, which is employed for neither visual nor automated analyses. However, this artifact is also correctable in a number of ways including an extended depth of field computation, for example via wavelet-based image processing, followed by a re-synthesis of evenly defocused image data.

The device and method of the present invention provides a three dimensional image that may be navigated in a very similar manner to traditional microscopy. More importantly, the focal information of the specimen is exhaustively represented, thus reducing the possibility of falsely interpreting specimen pathology that is possible in other systems due to a lack of critical focal information.

Furthermore, the focal image information may be collapsed to a single plane where all objects are synthetically in focus. This may be achieved using methods known to those skilled in the art of image analysis and may for example comprise a wavelet decomposition followed by coefficient selection and wavelet reconstruction. This type of image has several uses including more efficient image navigation without the requirement to re-focus therefore enabling robust and efficient image processing without the requirement to process multiple planes of focus and merge the results.

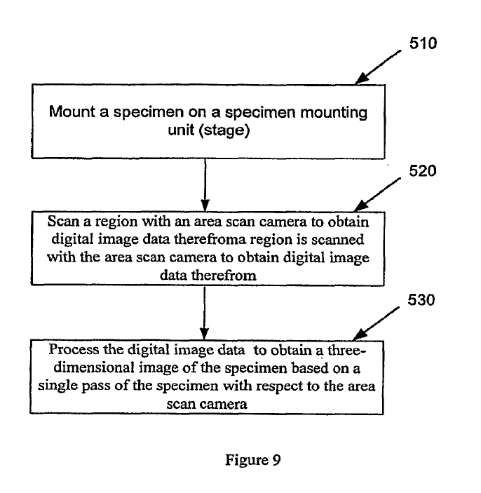

Turning now to FIG. 9, a method of collecting digital image data according to an embodiment of the invention will be described. In a first step 510, a specimen is mounted on a top surface of a specimen mounting unit, for enabling the specimen to be scanned by an area scan camera, the area scan camera having an optical scan axis. As discussed above, the top surface of the specimen mounting unit is slanted at an angle with respect to the area scan camera such that the optical scan axis is not orthogonal (e.g., oblique) to the top surface of the specimen mounting unit. In a second step 520, a region is scanned with the area scan camera to obtain digital image data therefrom. During this step, the specimen mounting unit is moved, such as in the primary movement direction shown in FIG. 3 of the drawings, whereby the movement is preferably at constant velocity. In a third step 530, the digital image data is processed to obtain a three-dimensional image of the specimen based on a single pass of the specimen with respect to the area scan camera.

The above-described method of the invention can be carried out using a scanning imaging microscope that meets the following design criteria. A principal requirement of the microscope stage is that the specimen slide is moved at an oblique angle to the optical centerline with high position precision and with absolute constant velocity. In order to achieve these two requirements, the microscope of the invention incorporates improvements over traditional scanning electromechanical stages.

Stages in almost all commercial microscopes incorporate three axis of motion, X and Y for translation of the slide to the optical axis and Z for the focusing axis. Lead screws, generally re-circulating ball bearing screws, are used to move the X and Y-axis. For the focusing axis, Z-axis, a gear rack and pinion system is generally used. When working to resolutions typically less than 50 nanometers, these systems are suboptimal. To achieve these high resolutions, another motion system is required.

High-resolution images demand superior system rigidity. In order to achieve this stable platform for the stage axis of motion, the scanning imaging microscope according to this invention is designed with a rigid, non-moveable, mounting to the microscope frame. This is in contrast to a conventional microscope frame where the stage assembly also moves in the focusing axis. By eliminating the focusing axis from this assembly, the X/Y scanning stage is now rigidly fastened to the frame. Designed into this rigid mounting is the ability to position one of the axes of motion at an oblique angle to the optical axis of the microscope. This oblique angle is dictated by the characteristics of the optics used for imaging and the magnification ratio as described above.

The focusing axis, Z-axis, is independent of the stage geometry and is mounted independently to the column component of the microscope assembly. The focusing axis of motion is geometrically parallel to the optical axis and eliminates the possibility of interaction between the X and Y stage motions.

In order to achieve nanometer resolution in the motion system and high geometric accuracy, the moving members are mounted on precision anti-friction ball or roller bearings, accurately preloaded to minimize yaw, pitch and roll errors. The prime movers in the system are ceramic piezo linear motors capable of motion resolution down to 1 nanometer. The system is operating in the closed loop servo mode with optical encoders providing positioning information to nanometer resolution.

Drive electronics include commercial servo controllers driving amplifiers developing the ultrasonic frequencies needed to operate the ceramic piezo motors at their resonant frequencies. The optical encoders feed directly into the servo controllers that in turn operate the motors and provide the trigger pulses for camera frame grab, pulsed illumination sources, focus motion, etc.

For automated processing, one axis of the stage motion may be extended to provide access for additional slide processing, i.e., slide marking, automated slide loading, low-resolution imaging, etc.

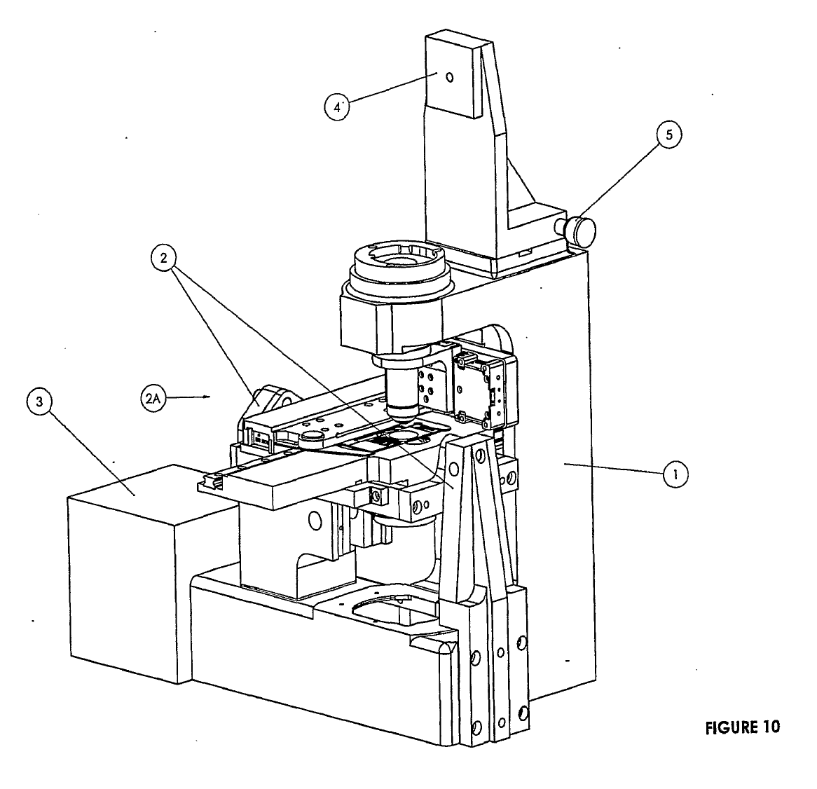

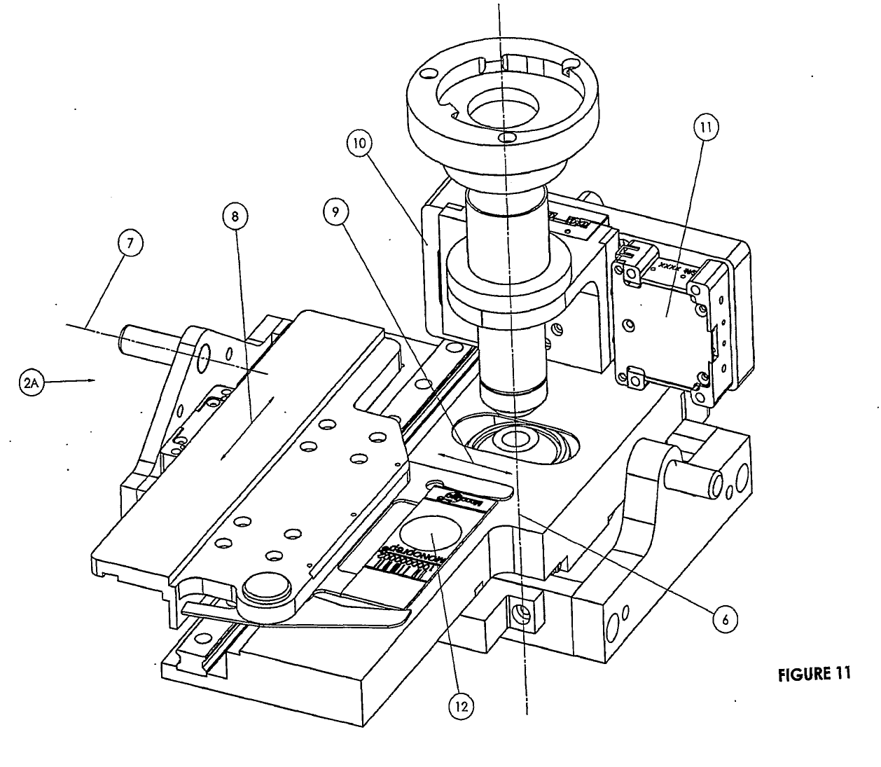

A description of a digital data collecting device according to an embodiment of the invention will be described below, with reference to FIGS. 10, 11 and 12. Referring now to FIG. 10, a microscope frame 1 is a rigidly constructed mounting for the digital data collecting device (also referred to herein as “microscope”), and is a mounting for a focusing assembly, an illumination system, and an imaging camera. A stage mounting section 2 rigidly supports a stage assembly 2A suspended on adjustable gimbals. Both ends of the stage assembly are supported and rigidly clamped into position. The indexing axis is perpendicular to the optical axis and the scanning axis is adjustable up to predetermined amount, for example, 6 degrees, oblique to the optical axis. An illumination source 3 is provided, and is configured to accept one or more illumination systems. A camera mount 4 is provided to rigidly fasten the camera/tube lens assembly (not shown in FIG. 10) to the microscope frame 1. The camera mount 4 can be rotated concentrically with the optical axis of the microscope. A camera azimuth adjustment 5 is provided, to allow microscopic camera azimuth adjustments to be made by a user to precisely align the scanning axis with the camera pixel array.

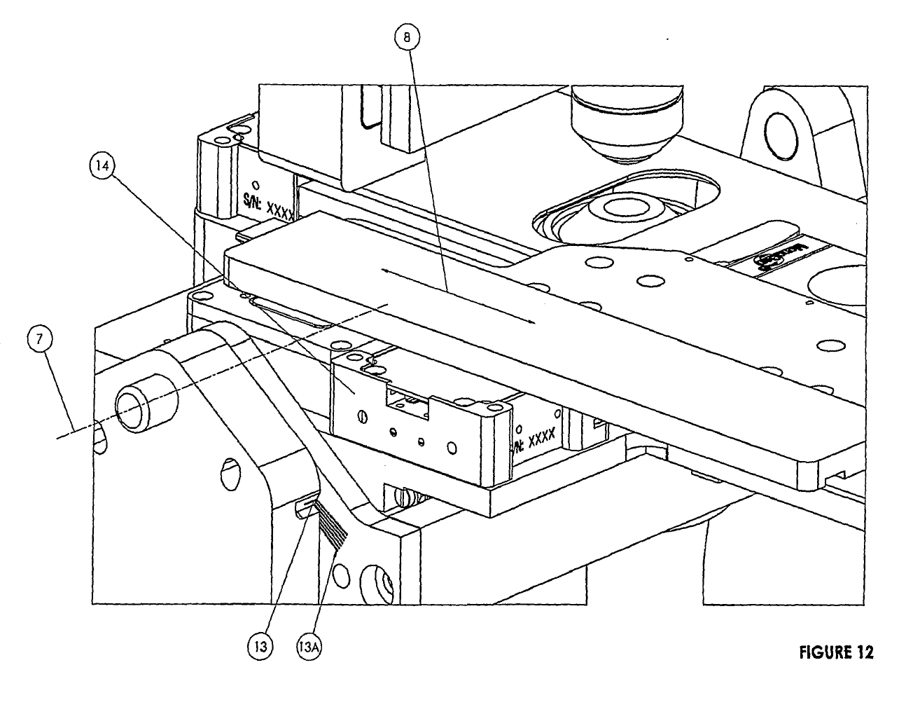

Referring now to FIG. 11, which primarily shows a stage assembly 2A of the microscope, the optical axis of the microscope is shown by way of line 6. With the exception of the tilting stage scanning axis, all other systems are parallel or perpendicular to the optical axis 6. Line 7 shows the stage center of rotation for the gimbals, which allow the scanning axis of the stage assembly to be rotated to an oblique angle relative to the optical axis 6. The stage center of rotation 7 is at the specimen image plane. Line 8 shows the scanning axis for a slide system that supports the specimen holding mechanism (that holds a specimen slide 12). The scanning axis 8 has additional travel to accommodate other operations such as slide loading, etc. Line 9 shows the indexing axis of the microscope, for a slide system to index and support the scanning axis assembly. The indexing system is driven by the action of an ultrasonic piezo motor, in one possible implementation of this embodiment. FIG. 11 also shows a focusing system 10. The focusing system includes a slide system that positions the microscope objective 6A on the optical axis 6 and has the capability of micro-positioning the optics to achieve image focus. The focusing system is driven by the action of an ultrasonic piezo motor in one possible implementation of this embodiment. In contrast to a conventional microscope, the slide system moves the infinity corrected objective lens only. FIG. 11 further shows a piezo motor housing 11, which houses the ultrasonic piezo motors used for movement of the focusing system. The ultrasonic piezo motors have the capability of making moves as small as one nanometer. FIG. 11 also shows a specimen slide 12, which may be a standard 25×75×1 mm laboratory slide, or any other type of slide.

FIG. 12 shows details of a portion of the microscope according to an embodiment of the invention, whereby the gimbal mount structure and the calibrations indicating the degree of tilt relative to the optical axis are shown. In more detail, an oblique angle gradation setting line 13 (provided on the gimbal) is set to one of a plurality of oblique angle gradations 13A (provided on the stage assembly) that respectively indicate the scanning axis oblique angle relative to the optical axis, whereby alignment of the setting line 13 to one of the line gradations corresponds to a fixed slant angle (e.g., 1 degree, 2 degrees, 3 degrees, etc.). FIG. 12 also shows a scanning axis drive motor housing 14 which houses drive motors, which are ultrasonic piezo motors used to respectively drive all axes of motion of the stage and the slide system. These motors have the capability of making moves as small as one nanometer.

Although the present invention has been described above and illustrated in the drawing figures by reference to certain embodiments of the invention, the invention is not limited to such embodiments, which are merely exemplary. Variations, alternatives, and modifications will occur to those skilled in the art, in light of the teachings herein, and all such variations, alternatives, and modifications are considered within the scope of the present invention.

What is claimed is:

1. A digital image collection system, comprising:
an area scan camera configured to scan a region to obtain digital image data therefrom, the area scan camera having an optical scan axis;
a specimen mounting unit configured to receive a specimen that is mounted on a top surface thereof, for enabling the specimen to be scanned by the area scan camera,
wherein the top surface of the specimen mounting unit is slanted at an angle with respect to the area scan camera such that the optical scan axis is oblique to the top surface of the specimen mounting unit.

2. The digital image collection system according to claim 1, further comprising:
a camera sensor;
a tube lens provided downstream of the camera sensor along the optical scan axis; and
an objective lens provided downstream of the tube lens of the camera sensor along the optical scan axis.

3. The digital image collection system according to claim 1, further comprising:
a moving unit configured to move the specimen mounting unit along a single plane with respect to the area scan camera,
wherein the optical scan axis is provided along a Z-direction in an X, Y, Z three-dimensional coordinate system.

4. The digital image collection system according to claim 1, wherein the angle at which the top surface of the specimen mounting unit is slanted with respect to the area scan camera is between 2 degrees and 10 degrees.

5. The digital image collection system according to claim 1, wherein the angle at which the top surface of the specimen mounting unit is slanted with respect to the area scan camera is determined based on a thickness of the specimen to be imaged.

6. The digital image collection system according to claim 1, wherein the area scan camera comprises a plurality of line scan cameras mounted optically such that each of the line scan cameras receives a unique focal position or lens configuration that imposes a focal gradient on the area scan camera.

7. The digital image collection system according to claim 6, wherein each of the plurality of line scan cameras is configured to effectively scan a plurality of adjacent pixel positions along the X- and Y-axes of the specimen to be imaged.

8. The digital image collection system according to claim 3, wherein the moving unit is configured to move the specimen mounting unit at a constant velocity along the single plane.

9. The digital image collection system according to claim 1, wherein a Z-direction image of the specimen is obtained along with an X-direction image and a Y-direction image, in order to obtain a three-dimensional image of the specimen in one scan, with respect to an X, Y, Z three-dimensional coordinate system.

10. The digital image collection system according to claim 3, wherein the moving unit comprises at least one ultrasonic piezo motor.

11. The digital image collection system according to claim 1, wherein a focal gradient is projected onto the area scan camera due to moving the specimen on the specimen mounting unit along a single plane with respect to the area scan camera, in which the optical axis of the area scan camera corresponds to a Z-direction on an X, Y, Z three-dimensional coordinate system, the system further comprising:
a processing unit configured to sample different focal depths that are obtained across sensor dimension in a same plane as the angle of slant,
wherein the processing unit obtains a three-dimensional image of the specimen in a single pass of the specimen mounting unit on the single plane with respect to the area scan camera as a result thereof.

12. The digital image collection system according to claim 3, wherein a three-dimensional image of the specimen is obtained based on a single pass of the specimen mounting unit moved on the single plane with respect to the area scan camera, the single plane resulting in the specimen being moved either closer to or farther away from the area scan camera during the single pass.

13. The digital image collection system according to claim 1, further comprising:
a processor section configured to determine a pair of color components for RGB color distinctions in the digital image data obtained by the area scan camera, based on a Bayer pattern,
wherein a third color component for the RBG color distinctions is obtained via interpolation.

14. A digital image collection method, comprising:
mounting a specimen on a top surface of a specimen mounting unit, for enabling the specimen to be scanned by an area scan camera, the area scan camera having an optical scan axis;
scanning a region with the area scan camera to obtain digital image data therefrom; and
processing the digital image data to obtain a three-dimensional image of the specimen based on a single pass of the specimen with respect to the area scan camera,
wherein the top surface of the specimen mounting unit is slanted at an angle with respect to the area scan camera such that the optical scan axis is oblique to the top surface of the specimen mounting unit.

15. The method according to claim 14, further comprising:
moving the specimen mounting unit along a single plane respect to the area scan camera,
wherein the optical scan axis is provided along a Z-direction in an X, Y, Z three-dimensional coordinate system.

16. The method according to claim 14, wherein the angle at which the top surface of the specimen mounting unit is slanted with respect to the area scan camera is between 2 degrees and 10 degrees.

17. The method according to claim 14, wherein the angle at which the top surface of the specimen mounting unit is slanted with respect to the area scan camera is determined based on a thickness of the specimen to be imaged.

18. The method according to claim 14, wherein the area scan camera comprises a plurality of line scan cameras mounted optically such that each of the line scan cameras receives a unique focal position or lens configuration that imposes a focal gradient on the area scan camera.

19. The method according to claim 18, wherein each of the plurality of line scan cameras is configured to effectively scan a plurality of adjacent pixel positions along the X- and Y-axes of the specimen to be imaged.

20. The method according to claim 16, wherein the specimen mounting unit is moved at a constant velocity along the single plane.

21. The method according to claim 14, wherein a Z-direction image of the specimen is obtained along with an X-direction image and a Y-direction image, in order to obtain a three-dimensional image of the specimen in one scan, with respect to an X, Y, Z three-dimensional coordinate system.

22. The method according to claim 14, wherein the specimen mounting unit is moved by way of at least one ultrasonic piezo motor.

23. The method according to claim 14, wherein a focal gradient is projected onto the area scan camera due to moving the specimen on the specimen mounting unit along the single plane, in which the optical axis of the area scan camera corresponds to a Z-direction on an X, Y, Z three-dimensional coordinate system, the processing step further comprising:
sampling different focal depths that are obtained across sensor dimension in a same plane as the angle of slant,
wherein the processing step obtains a three-dimensional image of the specimen in a single pass of the specimen mounting unit with respect to the area scan camera as a result thereof.

24. The method according to claim 15, wherein a three-dimensional image of the specimen is obtained based on a single pass of the specimen mounting unit moved on the single plane with respect to the area scan camera, the single plane resulting in the specimen being moved either closer to or farther away from the area scan camera during the single pass.

25. The method according to claim 14, further comprising:
determining a first pair of color components for RGB color distinctions in the digital image data obtained by the area scan camera, based on a Bayer pattern; and
determining a third color component for the RBG color distinctions via interpolation.

26. A computer program product embodied in computer readable media, the computer program product, when executed on a computer, causing the computer to perform the steps of:
mounting a specimen on a top surface of a specimen mounting unit, for enabling the specimen to be scanned by an area scan camera, the area scan camera having an optical scan axis;
scanning a region with the area scan camera to obtain digital image data therefrom; and
processing the digital image data to obtain a three-dimensional image of the specimen based on a single pass of the specimen with respect to the area scan camera,
wherein the top surface of the specimen mounting unit is slanted at an angle with respect to the area scan camera such that the optical scan axis is oblique to the top surface of the specimen mounting unit.

27. The computer program product according to claim 26, further comprising:
moving the specimen mounting unit along a single plane respect to the area scan camera,
wherein the optical scan axis is provided along a Z-direction in an X, Y, Z three-dimensional coordinate system.

28. The computer program product according to claim 26, wherein the angle at which the top surface of the specimen mounting unit is slanted with respect to the area scan camera is between 2 degrees and 10 degrees.

29. The computer program product according to claim 26, wherein the angle at which the top surface of the specimen mounting unit is slanted with respect to the area scan camera is determined based on a thickness of the specimen to be imaged.

30. The computer program product according to claim 26, wherein the area scan camera comprises a plurality of line scan cameras mounted optically such that each of the line scan cameras receives a unique focal position or lens configuration that imposes a focal gradient on the area scan camera.

31. The computer program product according to claim 30, wherein each of the plurality of line scan cameras is configured to effectively scan a plurality of adjacent pixel positions along the X- and Y-axes of the specimen to be imaged.

32. The computer program product according to claim 27, wherein the specimen mounting unit is moved at a constant velocity along the single plane.

33. The computer program product according to claim 26, wherein a Z-direction image of the specimen is obtained along with an X-direction image and a Y-direction image, in order to obtain a three-dimensional image of the specimen in one scan, with respect to an X, Y, Z three-dimensional coordinate system.

34. The computer program product according to claim 26, wherein the specimen mounting unit is moved by way of at least one ultrasonic piezo motor.

35. The computer program product according to claim 26, wherein a focal gradient is projected onto the area scan camera due to moving the specimen on the specimen mounting unit along the single plane, in which the optical axis of the area scan camera corresponds to a Z-direction on an X, Y, Z three-dimensional coordinate system, the processing step further comprising:
sampling different focal depths that are obtained across sensor dimension in a same plane as the angle of slant,
wherein the processing step obtains a three-dimensional image of the specimen in a single pass of the specimen mounting unit with respect to the area scan camera as a result thereof.

36. The computer program product according to claim 27, wherein a three-dimensional image of the specimen is obtained based on a single pass of the specimen mounting unit moved on the single plane with respect to the area scan camera, the single plane resulting in the specimen being moved either closer to or farther away from the area scan camera during the single pass.

37. The computer program product according to claim 26, further comprising:
determining a pair of color components for RGB color distinctions in the digital image data obtained by the area scan camera, based on a Bayer pattern; and
determining a third color component for the RBG color distinctions via interpolation.
